(19) United States
(12) Patent Application Publication
(10) Pub. No.: US 2004/0243734 A1
(43) Pub. Date: Dec. 2, 2004

(54) Information processing apparatus, method of controlling the same, control program, and storage medium

(75) Inventors: Eiichirou Kitagawa, Kanagawa (JP); Kazunari Watanabe, Kanagawa (JP)

Correspondence Address: ROSSI & ASSOCIATES, P.O. BOX 826, ASHBURN, VA, 20146-0826, US

(73) Assignee: CANON KABUSHIKI KAISHA

(21) Appl. No.: 10/846,446

(22) Filed: May 14, 2004

(30) Foreign Application Priority Data
May 26, 2003 (JP) 2003-147845 (PAT.
May 28, 2003 (JP) 2003-151014 (PAT.

(51) Int. Cl. G06F 3/00

(52) U.S. Cl. 710/13

(57) ABSTRACT

An information processing apparatus which can improve security for a storage unit comprised of removable media or removable storage devices. The removable media or removable storage devices are attached to drive bays of the information processing apparatus. A first controller controls the operation of the information processing apparatus, and a second controller controls the operation of the drive bays. The first controller cooperates with the second controller.

### BACKGROUND OF THE INVENTION

1. Field of the Invention

The present invention relates to an information processing apparatus, a method of controlling the apparatus, a control program for executing the method, and a storage medium storing the program, and more particularly to an information processing apparatus such as a server apparatus that stores data in a storage section comprised of removable media or removable storage devices, a method of controlling the apparatus, a control program for executing the method, and a storage medium storing the program.

2. Description of the Related Art

In recent years, the spread of broadband communications has facilitated the transfer of large-volume data and the transfer of files.

For example, ordinary families have increased their affinity with the Internet; they cannot only send and receive electronic mails and review websites, but also can exchange various data and files such as images and music with anybody and at anytime.

Similarly, in office environments, various kinds of information which were considered unrelated to computerization, such as sound, moving images, high-quality photographic images, have been computerized into large-volume data and files.

Such data and files are stored in e.g. a database of a server apparatus as an information processing apparatus. The server apparatus manages information stored in the database.

In particular, many server apparatuses used in companies are constructed such that a plurality of storage media such as a plurality of hard disk drives (HDD) are arranged in a disk array according to RAID (Redundant Arrays of Inexpensive Disks) so as to increase the capacity of the storage media.

The recently created iVDR standards (Information Versatile Disk for Removable Usage) can be applied to such a disk array. The iVDR standards are intended to use a storage device such as a small-sized HDD as a removable medium, and can be applied to a wide range of apparatuses such as AV equipment including server apparatuses and personal computers (PCs).

An HDD which is in conformity with the iVDR standards is comprised of a housing for protecting the HDD from shock during carriage, and a connector designed to safely and easily attach/remove the HDD to/from a drive bay for removably housing a single HDD.

If the iVDR standard is applied to a disk array constituting part of the server apparatus, a user can easily attach/remove removable media to/from the server apparatus, and can easily replace a broken HDD in each drive bay without taking apart the server apparatus. Further, a plurality of users can share one server apparatus since the disk array is comprised of a plurality of HDDs.

By the way, the server apparatus is required to have a high-security level so as to prevent unauthorized third parties from removing removable media, such as an HDD which stores a system program for the server apparatus (hereinafter referred to as the “system disk”), an HDD which stores data except programs (hereinafter refereed to as the “data disk”), and a backup tape which records backup data, from the server apparatus.

To this end, the server apparatus is provided with keyed covers which cover removable media or drive bays, and the keyed covers are locked/unlocked using physical keys.

If an unauthorized third party obtains such a physical key, he/she can shut off power supply to the main body of the server apparatus, unlock a cover to remove a removable medium from a drive bay, copy the contents stored in the removable medium to another medium, put the removable medium back into the drive bay, and restore the power supply to the main body of the server apparatus when there is no administrator of the server apparatus. This is because a history holder provided ordinarily in the main body of the server apparatus, for recording the operative status of the server apparatus does not operate while the power supply to the main body of the server apparatus is off. Namely, the administrator does not know the operative statuses of the covers such as lock/unlock, opening/closing of the covers, and attachment/removal of the removable media while the power supply to the main body of the server apparatus is off, and therefore, a high-security level cannot be ensured.

In view of the foregoing, in recent years, a cover electronic locking technique has been proposed which enables opening/closing of covers according to password authentication results without using physical keys in opening/closing the covers (refer to Japanese Laid-Open Patent Publication (Kokai) No. 2000-194448, for example). If the user is successfully authenticated according to a password, he/she is given an access right to open/close the covers, attach/remove removable media, and access data stored in the removable media.

According to this technique, however, when the power supply to the main body of the server apparatus is off, it is impossible to open/close the covers and attach/remove the removable media since electronic locking/unlocking does not function due to blackout, shutdown of an information processing system including the server apparatus, or the like, and this is inconvenient.

Therefore, a server apparatus (computer) has been proposed which is provided with an electronic lock control microprocessor connected to a power source provided independently of a power source for the main body of the server apparatus, and is capable of communicating with a network (refer to Japanese Laid-Open Patent Publication (Kokai) No. 2002-373030, for example). According to this technique, even when the power supply to the main body of the server apparatus is off, operative statuses of e.g. covers can be recorded so that removable media can be managed.

However, according to the technique disclosed in Japanese Laid-Open Patent Publication (Kokai) No. 2002-373030, it is possible to manage the removable media, but if a system administrator of an information processing system that includes the server apparatus and a data administrator (user) of removable media or data stored therein are different, the system administrator who is not the data administrator can attach/remove the removable media.

That is, the system administrator who has no access right is authorized to attach/remove the removable media, and hence a high-security level cannot be reliably ensured.

Further, the electronic lock control microprocessor functions irrespective of the history holder which records the status of the main body of the serve apparatus, to manage the removable media, and hence the operative statuses of the covers while the power supply to the main body of the server apparatus is off cannot be recognized referring to histories recorded in the history holder of the server apparatus.

Furthermore, if the server apparatus is activated when one system disk storing the system program is removed and another system disk is inserted, consistent operations in accordance with the system program in the information processing system cannot be ensured, and also security for the data disk cannot be ensured.

Further, various resources such as a power source for the electronic lock control microprocessor, a communication network provided between the electronic lock control processor and the main body of the server apparatus, and ports and IP addresses for the communication network are required, and this increases the cost of the server apparatus.

### SUMMARY OF THE INVENTION

It is a first object of the present invention to provide an information processing apparatus, a method of controlling the apparatus, and a control program, which can improve security for a storage unit comprised of removable media.

It is a second object of the present invention to provide an information processing apparatus, a method of controlling the apparatus, and a control program, which can improve security for a storage unit comprised of removable media or removable storage devices at low cost.

To attain the above first and second objects, in a first aspect of the present invention, there is provided an information processing apparatus comprising an attachment section to which a removable storage unit is attached, a first controller that controls operation of the information processing apparatus, and a second controller that controls operation of the attachment section, wherein the first controller cooperates with the second controller.

According to the first aspect of the present invention, it is possible to improve security for the storage unit comprised of removable media or removable storage devices at low cost.

To attain the above first and second objects, in a second aspect of the present invention, there is provided a method of controlling an information processing apparatus including an attachment section to which a removable storage unit is attached, comprising a first control step of controlling operation of the information processing apparatus through a first controller, and a second control step of controlling operation of the attachment section through a second controller, wherein the first control step is executed in cooperation with the second control step.

According to the second aspect of the present invention, it is possible to improve security for the storage unit comprised of removable media or removable storage devices at low cost.

To attain the above first and second objects, in a third aspect of the present invention, there is provided a control program for causing a computer to execute a method of controlling an information processing apparatus including an attachment section to which a removable storage unit is attached, comprising a first control module for controlling operation of the information processing apparatus through a first controller, and a second control module for controlling operation of the attachment section through a second controller, wherein the first control module cooperates with the second control module.

According to the third aspect of the present invention, it is possible to improve security for the storage unit comprised of removable media or removable storage devices at low cost.

The above and other objects, features, and advantages of the invention will become more apparent from the following detailed description taken in conjunction with the accompanying drawings.

### BRIEF DESCRIPTION OF THE DRAWINGS

FIG. 1 is a block diagram schematically showing the construction of an information processing system including an information processing apparatus according to a first embodiment of the present invention;

FIG. 2 is a block diagram showing the internal construction of a server apparatus appearing in FIG. 1;

FIG. 3 is a partial block diagram showing component elements related to management of storage units appearing in FIG. 2;

FIG. 4 is a flow chart showing a removable media management process carried out by a first controller appearing in FIG. 3;

FIG. 5 is a partial block diagram showing component elements related to a first cover unlocking process for covers appearing in FIG. 2;

FIG. 6 is a flow chart showing the first cover unlocking process carried out by a second controller appearing in FIG. 5;

FIG. 7 is a block diagram schematically showing essential parts of an information processing system including an information processing apparatus according to a second embodiment of the present invention;

FIG. 8 is a block diagram showing component elements related to a second cover unlocking process carried out by the information processing apparatus according to the second embodiment;

FIG. 9 is a flow chart showing the second cover unlocking process carried out by a second controller appearing in FIG. 8;

FIG. 10 is a block diagram showing the internal construction of an information processing apparatus according to a third embodiment of the present invention;

FIG. 11 is a flow chart showing a power supply turning-off process carried out by a server apparatus appearing in FIG. 10;

FIG. 12 is a flow chart showing a part of a removable disk management process carried out when power supply to a first controller appearing in FIG. 11 is turned off by the power supply turning-off process in FIG. 11;

FIG. 13A is a flow chart showing a continued part of the removable disk management process of FIG. 12;

FIG. 13B is a flow chart showing a continued part of the process of FIG. 13A;

FIG. 14 is a flow chart showing a continued part of the process of FIG. 13B;

FIG. 15 is a flow chart showing a continued part of the process of FIG. 14;

FIG. 16 is a flow chart showing a first controller activating process; and

FIG. 17 is a view showing an example of history information recorded in an internal memory of a second controller in the processes in FIGS. 11 to 17.

### DETAILED DESCRIPTION OF THE PREFERRED EMBODIMENTS

The present invention will now be described in detail with reference to the drawings showing preferred embodiments thereof. In the drawings, elements and parts which are identical throughout the views are designated by identical reference numerals, and duplicate description thereof is omitted.

A description will now be given of a first embodiment of the present invention.

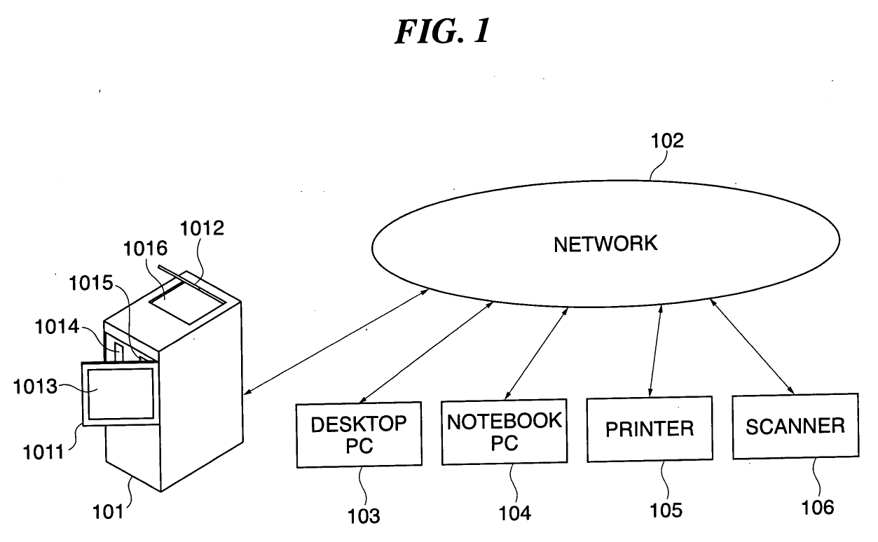

FIG. 1 is a block diagram schematically showing the construction of an information processing system including an information processing apparatus according to the first embodiment.

As shown in FIG. 1, the information processing system is comprised of a server apparatus 101, and personal computers (PCs) 103 and 104 and user terminals 105 and 106, which are connected to the server apparatus 101 via a network 102 such as a personal area network. The server apparatus 101 has a function of issuing IDs to various media and others and a function of collectively managing them, and encrypts data stored therein and carries out various processes such as authentication according to various kinds of ID information in response to a request to access each piece of the data.

The server apparatus 101 includes a plurality of drive bays 1014 to 1016 for housing dedicated or general-purpose removable storage devices (hereinafter referred to as “removable media”), a cover 1011 located at the front of the server apparatus 101, for covering the drive bays 1014 and 1015, and a cover 1012 for covering the drive bay 1016. It should be noted that doors may be provided in place of the covers.

The covers 1011 and 1012 are configured to be electronically locked in the state in which they are closed to prevent attached storage devices from being easily taking out. The cover 1011 located at the front is provided with a screen display section 1013 with a touch panel, on which various information can be displayed and through which various settings and information (such as a password) can be input by touching a screen thereof with a pen, for example.

The network 102 is managed by the server apparatus 101. The personal computer 103, which is a desktop PC, is for sending data to the server apparatus 101, or for accessing data stored in the server apparatus 101.

The personal computer 104, which is a notebook PC, is for sending data to the server apparatus 101, or for accessing data stored in the server apparatus 101.

The user terminal 105, which is a printer, prints data stored in various terminals and in the server apparatus 101. The user terminal 106, which is a scanner, sends read image information to the user terminals 103 to 105 and the server apparatus 101.

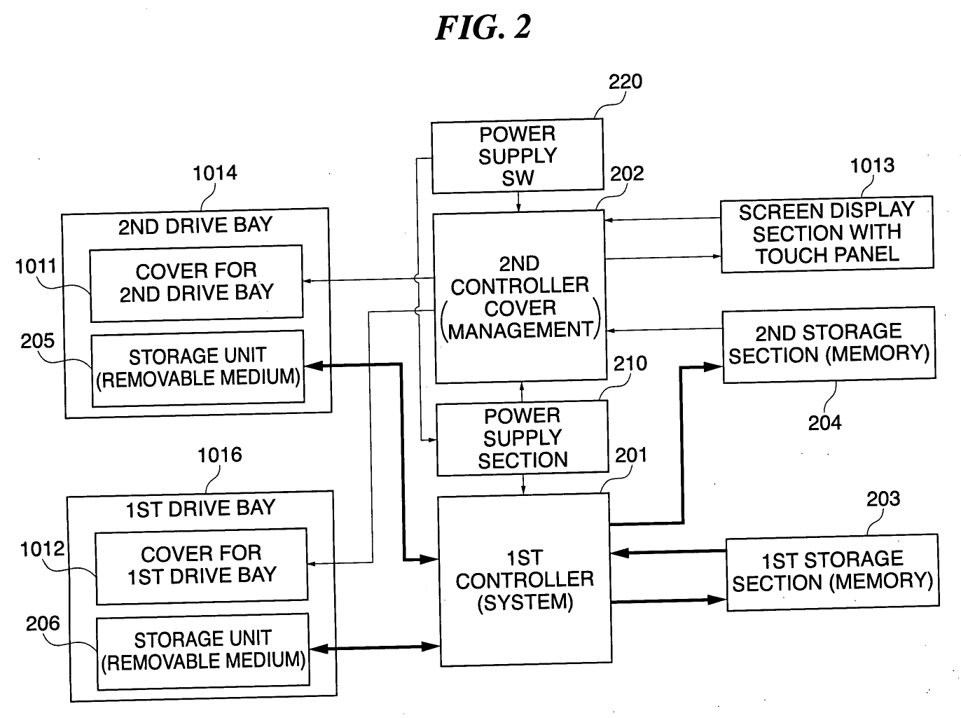

FIG. 2 is a block diagram showing the internal construction of the server apparatus 101 in FIG. 1.

The server apparatus 101 is provided with two controllers, i.e. a first controller 201 and a second controller 202. The first controller 201 controls the overall functions of the server apparatus 101. On the other hand, the second controller 202 mainly provides control to lock/unlock the covers 1011 and 1012 for the drive bays 1014 to 1016, controls display of the screen display section 1013, and provides control to process information input via the touch panel and others.

The first controller 201 and the second controller 202 are supplied with electric power from power sources, not shown, provided independently of each other in a power supply section 210. Even when power supply to the first controller 201 is off, power supply to the second controller 202 can be turned on if a power supply switch 220 is turned on. Here, the thick arrows in FIG. 2 indicate the flow of control signals and information transmitted under the control of the first controller 201, while the thin arrows in FIG. 2 indicate the flow of control signals and information transmitted under the control of the second controller 202.

A first storage section 203 connected to the first controller 201 is a memory which stores management information associated with the first controller 201. The first storage section 203 stores ID information on removable media housed in respective drive bays, ID information on respective pieces of data stored in the respective removable media, or ID information on the user terminals 103 to 106 connected to the network 102.

Also, information on authorized users having access rights is stored in the first storage section 203 in association with respective pieces of the ID information, and a table showing the relationship between the authorized users and the respective pieces of the ID information, i.e. which users are authorized to access which ID information, is also stored. The authorized users are specific users who are permitted to open/close covers, attach/remove removable media, and access data stored in the removable media when they are authenticated according to passwords by the above-mentioned authentication. The ID information, the table, and so forth are updated as needed according to changes in the status of the server apparatus 101 or the user terminals 103 to 106.

A second storage section 204 connected to the second controller 202 is a memory which stores management information associated with the second controller 202, e.g. management information on the covers 1011 and 1012. The second storage section 204 stores user information on users who are authorized to lock/unlock the covers 1011 and 1012 for the drive bays 1014 to 1016. Here, the user information includes passwords which can identify users; users and passwords correspond one-to-one with each other. The user information is used for ascertaining whether a request to lock/unlock the cover 1011 and/or the cover 1012 has been made by the user corresponding to the stored user information. Accordingly, the user information is automatically updated when users who manage attached removable media or users who manage data stored in the removable media are changed.

Storage units 205 and 206 are removable media to be attached to the drive bays 1014 and 1016, respectively. Examples of the removable media include not only storage devices (such as hard disk drives (HDDs)) with exclusive interfaces, and special storage devices (disk array) comprised of a plurality of storage devices, but also general-purpose removable media such as DVD media and CD media. Further, data to be stored in the storage units 205 and 206 include not only various kinds of information, but also an operating system (OS) and application software for controlling the overall operation of the information processing system.

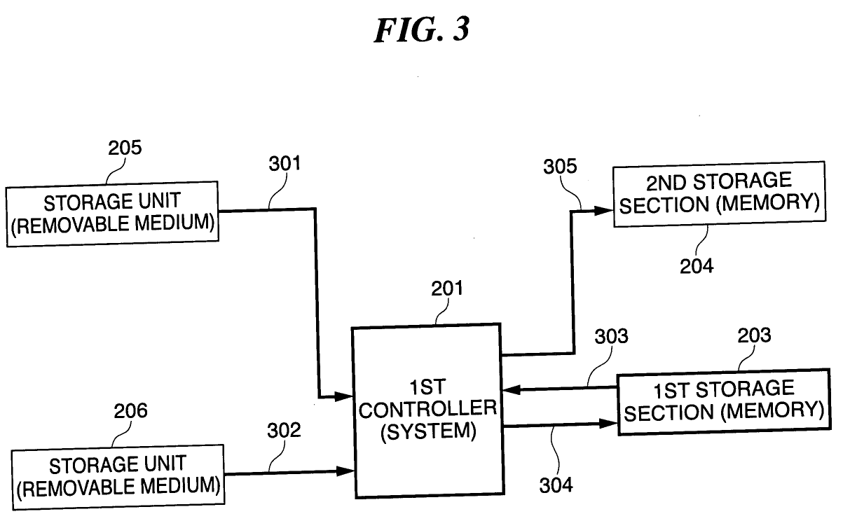

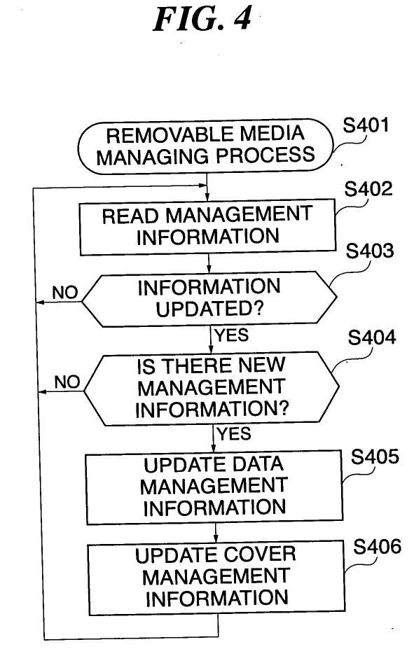

Referring next to FIGS. 3 and 4, a description will be given of how to manage the storage units 205 and 206 attached to the server apparatus 101.

FIG. 3 is a partial block diagram showing component elements related to management of the storage units 205 and 206 in FIG. 3. It should be noted that the component elements appearing in FIG. 3 are those which are capable of operating independently of the second controller 202 among the component elements appearing in FIG. 2.

Namely, the component elements appearing in FIG. 3 consist of the first controller 201, the storage units 205 and 206 connected to the first controller 201, the first storage section 203, and the second storage section 204, which are capable of operating irrespective of whether the power supply to the second controller 202 is on or off.

FIG. 4 is a flow chart showing a removable media managing process carried out by the first controller 201 appearing in FIG. 3. It should be noted that the following control method is executed by operation of a program based on the flow chart of FIG. 4, which is stored in e.g. the storage unit 205 or 206.

In FIG. 4, first, in a step S401 just after the power supply to the first controller 201 is turned on, the process is started. Then, in a step S402, management information on the storage units 205 and 206 (removable media) attached to the server apparatus 101 is read from the storage units 205 and 206. The flow of signals during this processing is indicated by arrows 301 and 302 in FIG. 3. Here, the management information includes detection information indicative of whether removable media (hereinafter referred to as “media”) are attached to the drive bays 1014 and 1016 of the server apparatus 101, information indicative of the types of the media, ID information indicative of media IDs, as well as information indicative of the types of data stored in the media and information indicative of users who manage the media, which are recorded as needed.

In a step S403, it is determined whether the management information read from the storage units 205 and 206 is updated information or not, and in a step S404, it is determined whether new management information has been detected or not. The first controller 201 carries out these determinations by reading the management information on the storage units 205 and 206, and comparing them with management information stored in advance in the first storage section 203. The flow of a signal from the first storage section 203 during this processing is indicated by the arrow 303 in FIG. 3. If a change in the management information due to update or new management information is detected, the process proceeds to a step S405, and if not, the process returns to the step S402.

In the step S405, the management information stored in the first storage section 203 is updated so as to reflect the latest management information on the storage units 205 and 206. The flow of a signal to the first storage section 203 during this processing is indicated by an arrow 304 in FIG. 3.

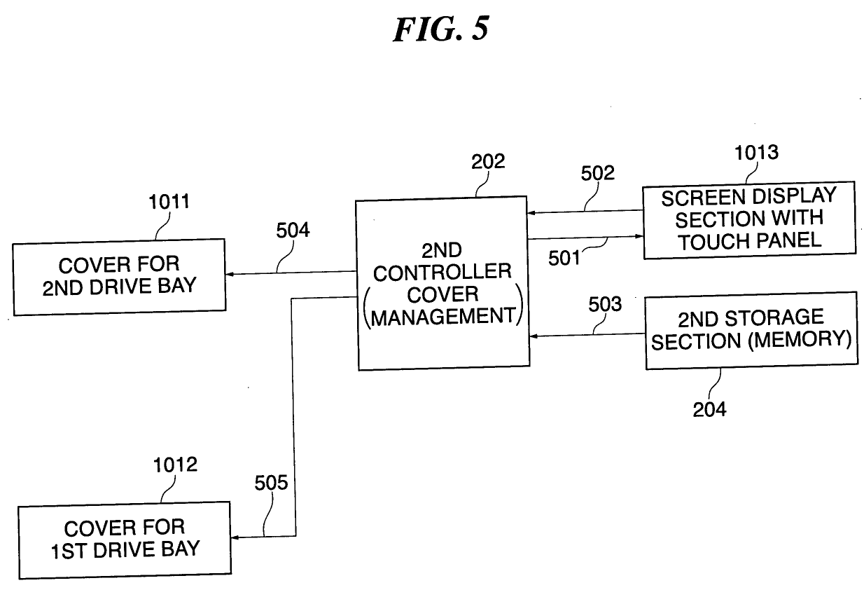

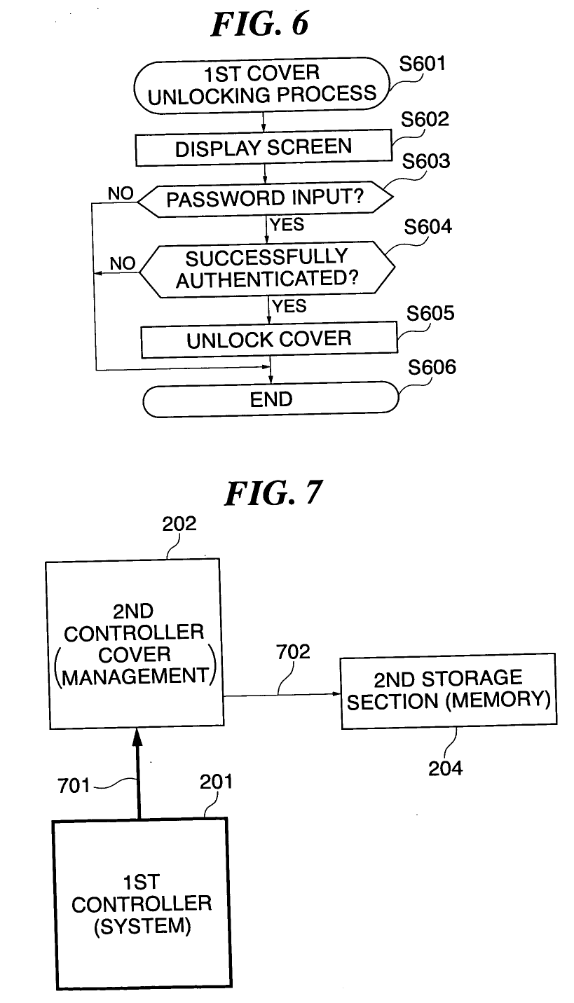

In a step S406, cover management information stored in the second storage section 204 is updated. The flow of a signal during this processing is indicated by the arrow 305 in FIG. 3. The processing in the step S406 enables the user who manages the storage unit 205 and/or the storage unit 206 to lock/unlock the cover 1011 and/or the cover 1012 of the server apparatus 101 (refer to FIGS. 5 and 6).

A description will now be given of a process for unlocking the covers 1011 and 1012 of the server apparatus 101 with reference to FIGS. 5 and 6.

FIG. 5 is a partial block diagram of FIG. 2, showing component elements related to a first cover unlocking process carried out for the covers 1011 and 1012 in FIG. 2. The component elements appearing in FIG. 5 are those which are capable of operating independently of the first controller 201 among the component elements appearing in FIG. 2. Namely, the component elements appearing in FIG. 5 are capable of operating irrespective of whether the power supply to the first controller 201 is on or off.

FIG. 6 is a flow chart showing the first cover unlocking process carried out by the second controller 202 appearing in FIG. 5. It should be noted that the following control method is executed by operation of a program based on the flow chart of FIG. 6, which is stored in e.g. the storage unit 205 or 206.

In FIG. 6, first, in a step S601 immediately after predetermined operations are carried out for the server apparatus 101, the first cover unlocking process is started for either the cover 1011 or the cover 1012. Then, in a step S602, a screen for prompting selection of a cover to be unlocked and input of a password for unlocking the selected cover is displayed in the screen display section 1013 with the touch panel in the server apparatus 101. The flow of a signal during this processing is indicated by the arrow 501 in FIG. 5. Here, the password means information known in advance by a user who is authorized to unlock a cover, and is intended to identify the user who unlocks the cover.

Then, in a step S603, it is determined whether or not a password has been input or not after the selection of a cover to be unlocked. It is configured such that when a predetermined password is input to a predetermined location on the touch panel, the second controller 202 detects that “a password has been input”. The flow of a signal during this processing is indicated by the arrow 502 in FIG. 5. If the input of a password is detected, the process proceeds to a step S604, and if not, the process proceeds to a step S606.

In the step S604, authentication is carried out to determine whether it is determined whether the input password is correct or not. Whether the input password is correct or not is determined by comparing the input password with information on the user authorized to lock/unlock a cover, which is stored in the second storage section 204. The flow of a signal during this processing is indicated by an arrow 503 in FIG. 5. If the password is correct, the process proceeds to a step S605, and if not, the process proceeds to the step S606.

In the step S605, the selected cover is unlocked under the control of the second controller 202. The flow of a signal during this processing is indicated by the arrow 504 or 505 in FIG. 5. In the step S606, the first cover unlocking process is terminated. To unlock a cover again, the process returns to the step S601 after predetermined operations are carried out.

In the present embodiment, the first controller 201 and the second controller 202 provide control independently of each other (their power supplies are independent of each other), and therefore it is possible to configure an information processing system which requires input of a password or the like for attachment/removal of media even if the entire information processing system or the server apparatus 101 is off. Namely, even if the entire information processing system or the server apparatus 101 is off, the security for the storage units (media) 205 and 206 attached to the drive bays 1014 to 1016 can be continuously managed. Also, it is possible to prevent attachment of other storage units.

Further, since it is configured such that an administrator who manages one or more media and data therein is automatically regarded as an administrator who locks/unlocks one or both of the covers 1011 and 1012 for the drive bays 1014 to 1016, and is permitted to electronically lock/unlock one or both of the covers 1011 and 1012, only an administrator specific to one or more media is authorized to lock/unlock one or both of the covers 1011 and 1012 corresponding to the attached medium or media even if a plurality of users arbitrarily use the drive bays 1014 to 1016. Therefore, it is possible to prevent media from being easily attached/removed by the third party.

Further, since only the administrator who manages one or more media housed in the information processing apparatus 101 is authorized to unlock the corresponding cover(s) even if the power supply to the entire information processing system is off, security is not degraded even when an operation system (OS) and/or application software important for the information processing system are/is written to the medium or media attached to the corresponding drive bay(s).

A description will now be given of a second embodiment of the present invention. Elements, parts, and signals corresponding to those of the above described first embodiment are denoted by the same reference numerals, and description thereof is omitted.

FIG. 7 is a block diagram schematically showing the construction of essential parts of an information processing system including an information processing apparatus according to the second embodiment.

The arrangement according to the present embodiment is different from the arrangement in FIG. 3 in the flow of the signal indicated by the arrow 305. Specifically, unlike the first embodiment, user information such as administrator information is not directly written from the first controller 201 to the second storage section 204, but the second controller 202 writes user information such as administrator information to the second storage section 204 (a signal corresponding to the arrow 702 in FIG. 7) after notification is given from the first controller 201 to the second controller 202 (a signal corresponding to the arrow 701 in FIG. 7).

A description will now be given of a process for unlocking the covers 1011 and 1012, which is carried out by the second controller 202 of the server apparatus 101 as the information processing apparatus according to the present embodiment.

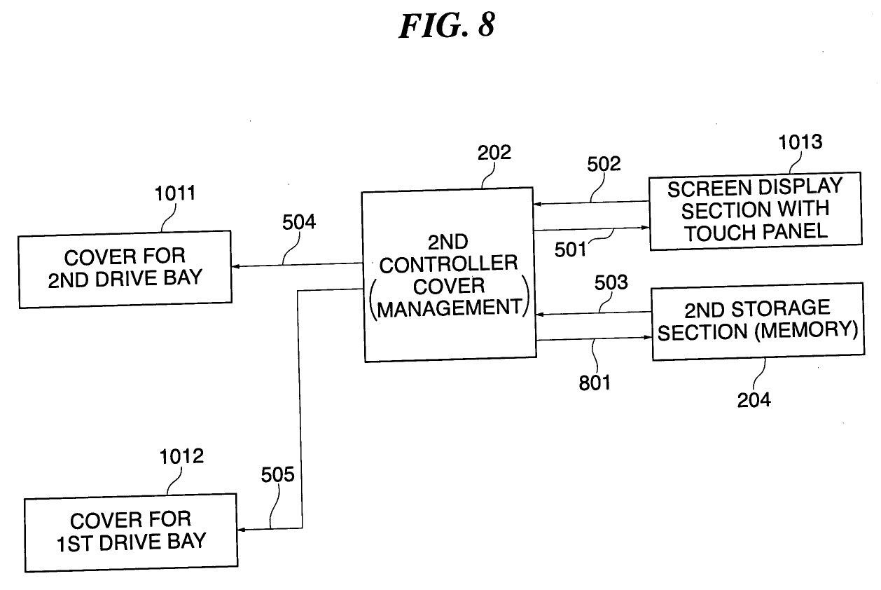

FIG. 8 is a block diagram showing component elements related to a second unlocking process carried out by the second controller 202. In FIG. 8, the arrow 801 corresponding to a signal for deleting password information is additionally provided between the second controller 202 and the second storage section 204 in FIG. 5.

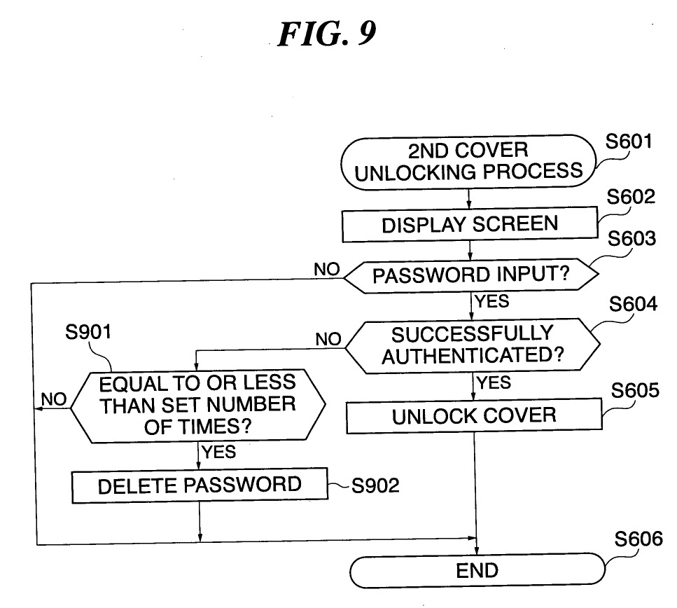

FIG. 9 is a flow chart showing the second cover unlocking process carried out by the second controller 202 in FIG. 8. It should be noted that the following control method is executed by operation of a program based on the flow chart of FIG. 9, which is stored in e.g. the storage unit 205 or 206.

The second cover unlocking process carried out in the present embodiment is different from the first cover unlocking process in FIG. 6 in that steps S901 to 902 are additionally provided, and processing in steps S601 to S606 in FIG. 9 is substantially the same as the above described processing in the steps S601 to S606 in FIG. 6. However, in the step S604 where password authentication is carried out to determine whether an input password is correct or not, if the password is not correct (i.e. the result of authentication is NG), the process proceeds to the step S901.

In the step S901, it is determined whether or not the number of times an incorrect password has been input is greater than a set number of times. Namely, it is configured such that the second controller 202 counts the number of times an incorrect password has been input in succession, and then determines whether or not the counted number of times is greater than the number of times set in advance. If the counted number of times is greater than the set number of times, the process proceeds to the step S902, and if not, the process proceeds to the step S606.

In the step S902, password information stored in the second storage section 204 is deleted. The flow of the signal during this processing is indicated by the arrow 801 in FIG. 8. After the password information is deleted, unlocking of the corresponding cover becomes almost impossible, and hence the removable medium or media attached to the drive bay(s) corresponding to the cover cannot be removed.

To register (reset) a password, the first controller 201 is activated by carrying out predetermined operations, so that the removable media management process described above with reference to FIG. 4 is carried out.

In the present embodiment, if an incorrect password is input several times so as to unlock a cover while the information processing system is down or off, a password is completely deleted to make it impossible to unlock the cover, and this increases security. Further, if the information processing system is reactivated by carrying out predetermined operations, a password can be automatically reset, and this makes it possible to easily reset a password, and improve convenience.

A description will now be given of a third embodiment of the present invention.

Among component elements constituting an information processing system including an information processing apparatus according to the third embodiment, elements and parts corresponding to those of the above described first embodiment in FIG. 1 are denoted by the same reference numerals, and description thereof is omitted.

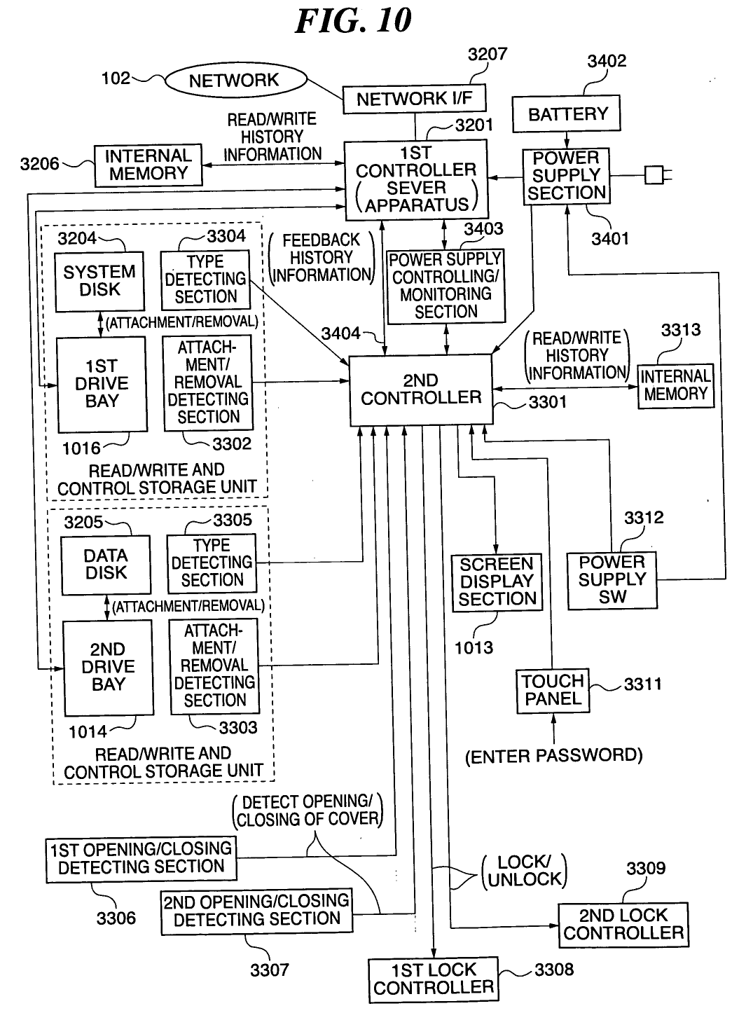

FIG. 10 is a block diagram showing the internal construction of the server apparatus 101 as the information processing apparatus according to the present embodiment.

In FIG. 10, the server apparatus 101 is provided with a first controller 3201 and a second controller 3301. In normal use, both the first controller 3201 and the second controller 3301 are operative. The first controller 3201 realizes various functions such as sharing of files and management of ID information for resources on the network 102. On the other hand, the second controller 3301 continues to constantly operate even when the power supply to the server apparatus 101 is off, and realizes a security management function relating to hardware of the server apparatus 101 such as a system disk 3204 and a data disk 3205, which are to be attached to the server apparatus 101, and a power supply switch 3312.

The first drive bay 1016 is for attachment of the system disk 3204 which is a hard disk drive (HDD) storing a system program realizing the functions of the first controller 3201. The second drive bay 1014 is for attachment of the data disk 3205 which is an HDD containing data stored by the server apparatus 101.

An internal memory 3206 stores history information managed by the server apparatus 101 and temporary information required for operation of the server apparatus 101. A network interface (I/F) 3207 provides interface so that the first controller 3201 can provide the functions of the server apparatus 101 for the terminals 103 to 106 connected to the network 102.

An attachment/removal detecting section 3302 detects attachment/removal of the system disk 3204 to/from the drive bay 1016. An attachment/removal detecting section 3303 detects attachment/removal of the data disk 3205 to/from the drive bay 1014.

A type detecting section 3304 detects the type of an HDD attached to the first drive bay 1016, i.e. a system disk or a data disk. A type detecting section 3305 detects the type of an HDD attached to the second drive bay 1014 as well as the type detecting section 3304.

The type detecting sections 3304 and 3305 apply test voltage to predetermined test pins of connectors, not shown, provided in HDDs attached to the first drive bay 1016 and the second drive bay 1014, respectively. If the test pin is energized, the HDD is detected as being the data disk 3205, and if the test pin is not energized, the HDD is detected as being the system disk 3204.

The system disk 3204 is not energized even if test voltage is applied thereto, since a conductive wire in a fuse disposed between the test pin and a ground pin is cut off in advance by high voltage. The data disk 3205 is energized if test voltage is applied thereto, since a conductive wire in a fuse disposed between the test pin and a ground pin is not cut off.

Even while the power supply from a power supply section 3401 to the first controller 3201 is off, the attachment/removal detecting sections 3302 and 3303 and the type detecting sections 3304 and 3305 continue their detecting operations, and transmit the detected information and types to the second controller 3301.

The first drive bay 1016 and the second drive bay 1014 are provided with the covers 1012 and 1011 with electronic locks, respectively, so as to prevent HDDs from being removed by unauthorized users. The covers 1012 and 1011 are opened/closed and locked/unlocked under the control of the second controller 3301.

A first opening/closing detecting section 3306 detects the opening/closing of the cover 1012 for the first drive bay 1016. A second opening/closing detecting section 3307 detects the opening/closing of the cover 1011 for the second drive bay 1014. The first opening/closing detecting section 3306 and the second opening/closing section 3307 detect a change in cover opening/closing status, and transmit information indicative of the change to the second controller 3301.

A first lock controller 3308 controls electronic lock of the cover 1012 for the first drive bay 1016, and a second lock controller 3309 controls electronic lock of the cover 1011 for the second drive bay 1014. Each of the first lock controller 3308 and the second lock controller 3309 locks/unlocks the cover in accordance with an instruction from the second controller 3301.

A touch panel 3311 is an input section which receives information on operation inputs from a user, and is formed integrally with the screen display section 1013 for showing information to the user. The power supply switch 3312 is for turning on/off the power supply to the first controller 3201; the depression of the power supply switch 3312 is detected by the second controller 3301 to perform predetermined processing.

An internal memory 3313 accumulates history information indicative of e.g. attachment/removal of HDDs to/from the respective drive bays, opening/closing of covers, electronic locking/unlocking of the covers, user authentication, and turning on/off of the power supply to the first controller 3201 in accordance with instructions from the second controller 3301.

The power supply section 3401 supplies power from an AC outlet to the first controller 3201 and the second controller 3301. A battery 3402 connected to the power supply section 3401 is a backup battery which supplies temporary power intended to urgently shut down the first controller 3201, and power intended to constantly operate the second controller 3301 to the power supply section 3401. A power supply controlling/monitoring section 3403 controls the power supply to the first controller 3201, and monitors the status of the power supply to the first controller 3201 in accordance with instructions from the second controller 3301.

The first controller 3201 and the second controller 3301 are connected to each other via an RS232C cable 3404, which is used for exchange (feedback) of history information including information indicative of the completion of activation between the two controllers 3201 and 3301.

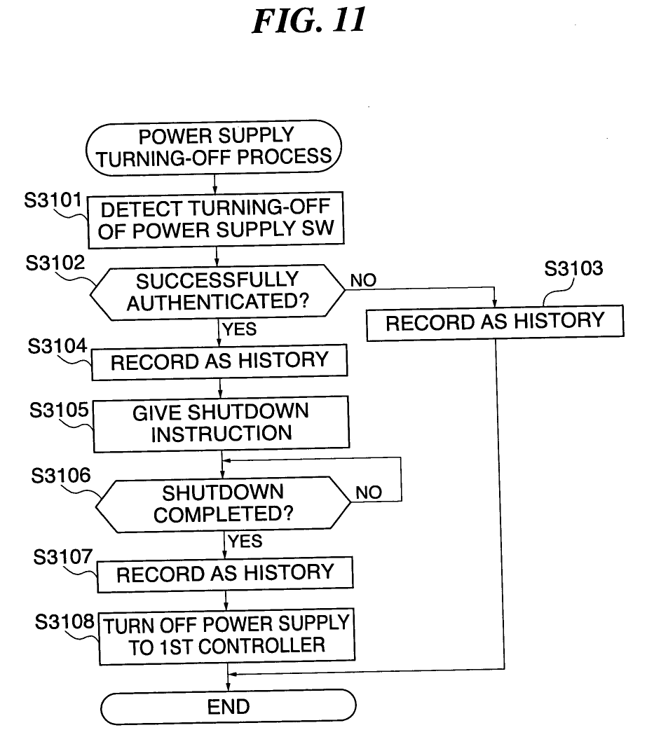

FIG. 11 is a flow chart showing a power supply turning-off process carried out by the server apparatus 101 in FIG. 10. It should be noted that the following control method is realized by operation of a program based on the flow chart of FIG. 11, which is stored in e.g. a memory within the second controller 3301.

In the present process, when a user depresses the power supply switch 3312 while both the first controller 3201 and the second controller 3301 are operating, the power supply to the first controller 3201 is turned off.

In FIG. 11, when the second controller 3301 detects the depression (turning off) of the power supply switch 3312 (step S3101), a screen for prompting input of a user name and a password is displayed in the screen display section 1013. When the user inputs a user name and a password depressing soft keys on the touch panel 3311, the input user name and password are compared with user information stored in the internal memory 3313 (step S3102). If they do not coincide, the user is unsuccessfully authenticated (NG); a message indicative of an authentication error is displayed in the screen display section 1013, and the error is recorded as history information in the internal memory 3313, and the process is terminated (step S3103).

If the user is successfully authenticated (OK), information indicative of the user name, time, and successful authentication resulting from the depression of the power supply switch 3312 is recorded as history information in the internal memory 3313 (step S3104). Then, the second controller 3301 communicates with the first controller 3201 via the cable 3404 to send a shutdown instruction (step S3105), and comes into a shutdown completion waiting state (step S3106).

When the first controller 3201 has been completely shut down (“YES” to the step S3106), the power supply controlling/monitoring section 3403 detects the shutdown of the power supply to the first controller 3201, and the second controller 3301 confirms the completion of shutdown. Then, information indicative of the completion of shutdown is recorded as history information in the internal memory 3313 (step S3107), and the first controller 3201 is brought into a power-off state (step S3108). The process is then terminated.

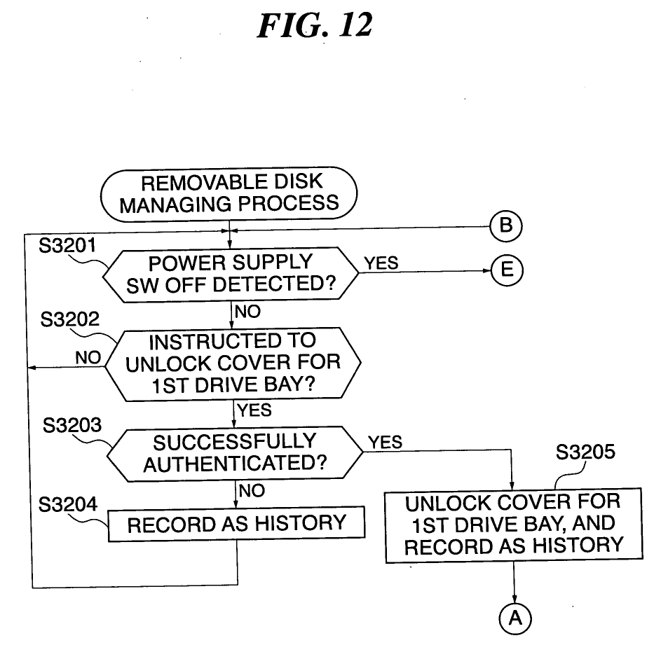

FIG. 12 is a flow chart showing a part of a removable disk management process carried out when the power supply to the first controller 3201 is turned off by the power supply turning-off process described with reference to FIG. 11. It should be noted that the following control method is realized by operation of a program based on the flow chart of FIG. 12, which is stored in e.g. the memory within the second controller 3301.

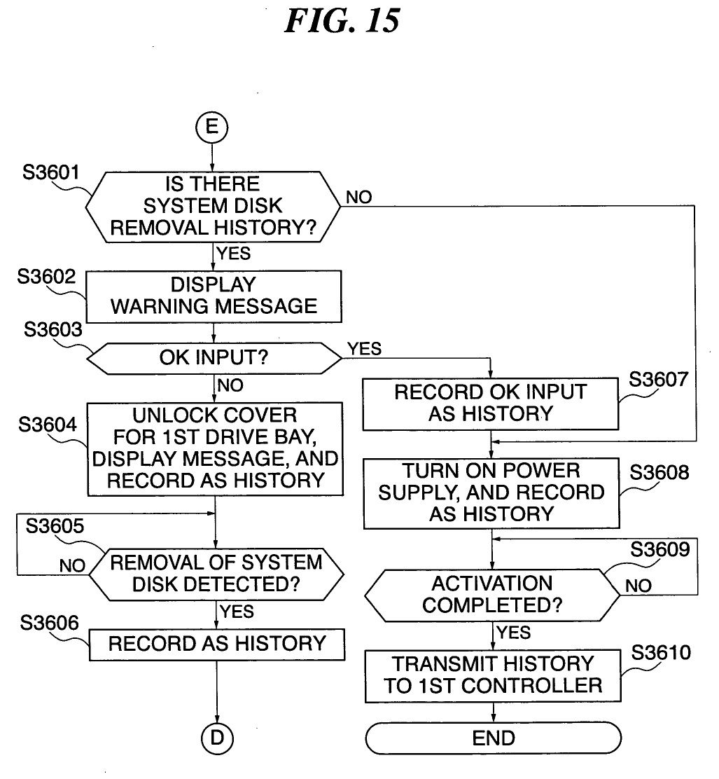

When a user depresses the power supply switch 3312 so as to activate the server apparatus 101, the depression of the power supply switch 3312 is detected (step S3201), and the process proceeds to carry out a power switch turning-on detecting process in FIG. 15, described later.

If the user wishes to remove the system disk 3204 without activating the server apparatus 101, it is necessary to unlock the cover 1012 for the first drive bay 1016. When the user causes a menu screen to be displayed in the screen display section 1013, and operates the touch panel 3311 to give an instruction for unlocking the cover 1012 for the first drive bay 1016, the second controller 3301 receives this instruction (step S3202) to display a user authentication screen in the screen display section 1013.

The user inputs data required for authentication via the touch panel 3311. The second controller 3301 compares the input user name and password with contents (user information) stored in the internal memory 3313 (step S3203). If the user is unsuccessfully authenticated, information indicative of unsuccessful authentication is recorded as history information in the internal memory 3313 (step S3204), and the process returns to the step S3201.

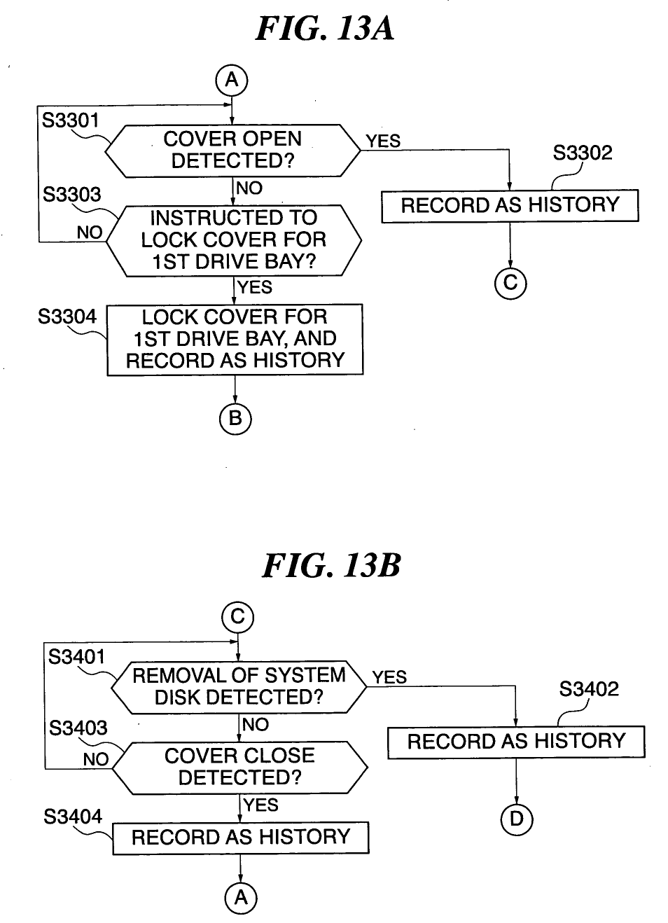

If the user is successfully authenticated, the second controller 3301 instructs the first lock controller 3308 to unlock the cover 1012, and information indicative of unlocking of the cover 1012 is recorded as history information in the internal memory 3313 (step S3205). Then, the process proceeds to carry out processing in a cover unlocked state as shown in FIG. 13A, described later.

FIG. 13A is a flow chart showing a continued part of the process of FIG. 12. It should be noted that the following control method is realized by operation of a program based on the flow chart of FIG. 13A, which is stored in e.g. the memory within the second controller 3301.

With the cover 1012 being unlocked, the user can open the cover 1012 for the first drive bay 1016. When the user opens the cover 1012, the first opening/closing detecting section 3306 detects the opening of the cover 1012 (step S3301), and information indicative of the opening of the cover 1012 is recorded as history information in the internal memory 3313 (step S3302). Then, the process proceeds to carry out processing in a cover opened state as shown in FIG. 13B, described later.

When the user gives an instruction for locking the cover 1012 with reference to the menu screen on the touch panel 3311 without opening the cover 1012, the second controller 3301 receives this instruction (“YES” to a step S3303), instructs the first lock controller 3308 to lock the cover 1012, and records information indicative of locking of the cover 1012 as history information in the internal memory 3313 (step S3304). Then, the process returns to carry out the processing in the power supply-off state of the first controller 3201 as shown in FIG. 12.

FIG. 13B is a flow chart showing a continued part of the process of FIG. 13A. It should be noted that the following control method is realized by operation of a program based on the flow chart of FIG. 13B, which is stored in e.g. the memory within the second controller 3301.

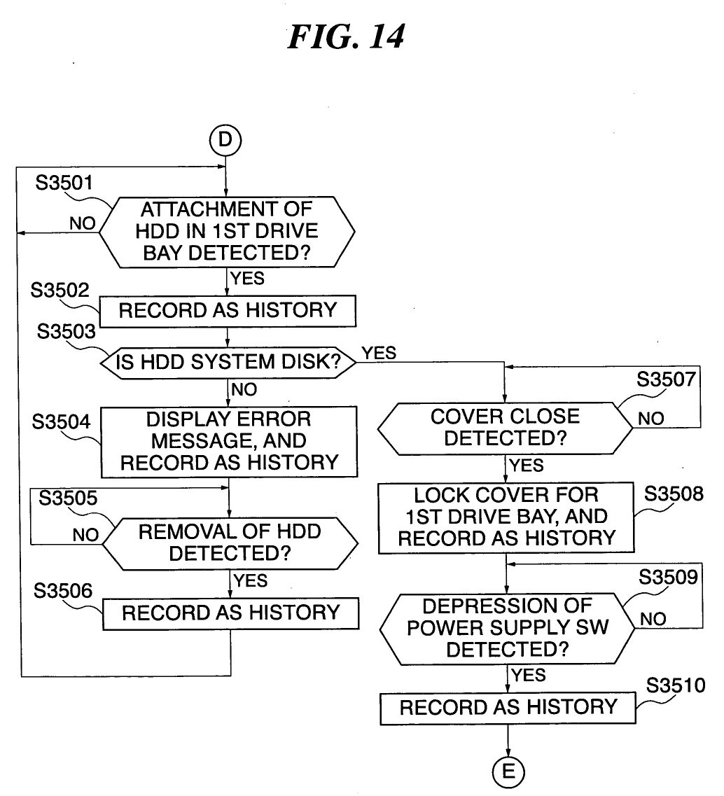

When the user removes the system disk 3204 by operating an eject lever, not shown, provided in a housing for the server apparatus 101 after opening the cover 1012 for the first drive bay 1016, the attachment/removal detecting section 3302 detects the removal of the system disk 3204 (step S3401), and records information indicative of the removal of the system disk 3204 as history information in the internal memory 3313 (step S3402). Then, the process proceeds to carry out the processing with the system disk 3204 removed from the first drive bay 1016 as shown in FIG. 14.

When the user closes the cover 1012 without removing the system disk 3204, the first opening/closing detecting section 3306 detects the closing of the cover 1012 (step S3403), and records information indicative of the closing of the cover 1012 as history information in the internal memory 3313 (step S3404). The process returns to carry out the processing in the cover unlocked state as shown in FIG. 13A.

FIG. 14 is a flow chart showing a continued part of the process of FIG. 13B. It should be noted that the following control method is realized by operation of a program based on the flow chart of FIG. 14, which is stored in e.g. the memory within the second controller 3301.

When the user attaches an HDD to the first drive bay 1016, the attachment/removal detecting section 3302 detects the attachment of the HDD (“YES” to a step S3501), and the second controller 3301 records information indicative of the attachment of the HDD as history information in the internal memory 3313 (step S3502). Also, the type detecting section 3304 detects whether the attached HDD is the system disk 3204 or the data disk 3205 (step S3503).

If the HDD attached by the user is the data disk 3205, an error message is displayed, and information indicative of the error, i.e. the attached HDD being the data disk 3205, is recorded as history information in the internal memory 3313 (step S3504). Then, when the user removes the data disk 3205, the attachment/removal detecting section 3302 detects the removal of the data disk 3205 from the first drive bay 1016 (“YES” to a step S3505), and the second controller 3301 records information indicative of the removal of the data disk 3205 from the first drive bay 1016 as history information in the internal memory 3313 (step S3506). The process then returns to the step S3501.

If the HDD attached by the user is the system disk 3204, the process proceeds to a step S3507. In the step S3507, when the user closes the cover 1012 for the first drive bay 1016, the first opening/closing detecting section 3306 detects the closing of the cover 1012, and information indicative of the closing of the cover 1012 is recorded as history information in the internal memory 3313. When the user gives an instruction for locking the cover 1012 through operation of the touch panel 3311, the second controller 3301 receives this instruction, instructs the first lock controller 3308 to lock the cover 1012, and records information indicative of the locking of the cover 1012 as history information in the internal memory 3313 (step S3508).

Then, when the user depresses (turns on) the power supply switch 3312, the second controller 3301 detects the depression (“YES” to a step S3509), and records information indicative of the depression as history information in the internal memory 3313 (step S3510). Then, the process proceeds to a system program activating process in FIG. 15, which is carried out after the attachment of the system disk 3204.

FIG. 15 is a flow chart showing a continued part of the process of FIG. 14. It should be noted that the following control method is realized by operation of a program based on the flow chart of FIG. 15, which is stored in e.g. the memory within the second controller 3301.

First, the second controller 3301 refers to the history information recorded in the internal memory 3313, and checks whether or not there is a history of removal of the system disk 3204 (step 3601). If there is no history of removal of the system disk 3204, the process proceeds to a step S3608, described later. If there is a history of removal of the system disk 3204, a warning message that there is a history of removal of the system disk 3204 is displayed in the screen display section 1013 (step S3602).

When the user inputs an instruction for canceling the activation of the system program stored in the system disk 3204 via the touch panel 3311 (“NO” to a step S3603), a predetermined message is displayed after the cover 1012 is unlocked, and then, information indicative of canceling of the activation of the system program and unlocking of the cover 1012 is recorded as history information in the internal memory 3313 (step S3604).

Then, when the attachment/removal detecting section 3302 detects the removal of the system disk 3204 (“YES” to a step S3605), the detention result (hereinafter referred to as “the history of the removal”) is recorded as history information in the internal memory 3313 (step S3606). The process then returns to carry out the processing with the system disk 3204 removed from the first drive bay 1016 as shown in FIG. 14.

When the user inputs “OK” indicating confirmation of the warning message via the touch panel 3311 (“YES” to the step S3603), information indicative of the confirmation (OK input) is recorded as history information in the internal memory 3313 (step S3607). Then, the power supply controlling/monitoring section 3403 is instructed to turn on the power supply to the first controller 3201, and information indicative of the turning-on of the power supply is recorded as history information in the internal memory 3313 (step S3608).

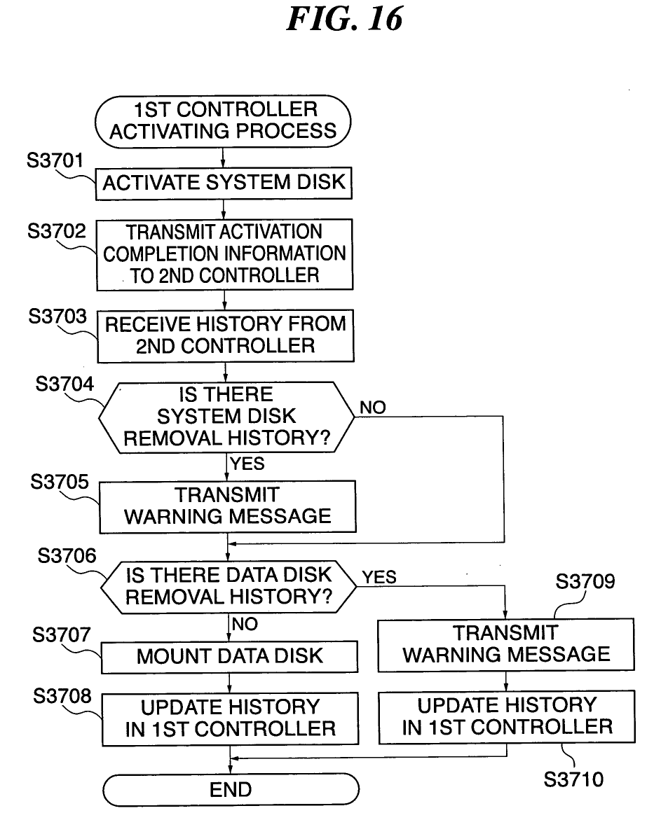

When the power supply to the first controller 3201 is turned on, the first controller 3201 reads the system program from the system disk 3204 attached to the first drive bay 1016, and loads the program into a memory within the first controller 3201 to execute the program. This completes the activation of the first controller 3201. Then, as described later with reference to FIG. 16, connection between the first controller 3201 and the second controller 3301 is established via the RS232C cable 3404, and the second controller 3301 confirms the completion of the activation (“YES” to a step S3609).

The second controller 3301 transmits all of the history information, which has been recorded in the internal memory 3313 after the power supply to the first controller 3201 is turned off, to the first controller 3201 (step S3610). Upon completion of the transmission, the second controller 3301 clears the history information accumulated in the internal memory 3313 to restore the normal execution state in which both the first controller 3201 and the second controller 3301 are on.

FIG. 16 is a flow chart showing a process for activating the first controller 3201. It should be noted that the following control method is realized by operation of a program based on the flow chart of FIG. 16, which is stored in e.g. the memory within the first controller 3201.

When the power supply to the first controller 3201 is turned on, a BIOS program stored in a ROM thereof is activated, and the system program stored in the system disk 3204 is read into the memory in accordance with the BIOS program, so that the first controller 3201 is activated (step S3701). Upon completion of the activation, the first controller 3201 establishes communication with the second controller 3301 via the RS232C cable 3404, and transmits information indicative of the completion of the activation of the first controller 3201 to the second controller 3301 (step S3702).

The first controller 3201 receives history information, which has been recorded while the power supply thereto is turned off, from the second controller 3301 (step S3703). Then, the first controller 3201 records the received history information in the internal memory 3206, and determines whether or not there is a history of removal of the system disk 3204 (step S3704). If there is a history of removal of the system disk 3204, a warning message is transmitted to a PC set in advance by a server administrator, e.g. the desktop PC 103 via the network 102 (step S3705), and the process proceeds to a step S3706. If there is no history of removal of the system disk 3204, the process proceeds to the step S3706 with the step S3705 being skipped.

In the step S3706, it is ascertained whether or not there is a history of removal of the data disk 3205. If there is no history of removal of the data disk 3205, it can be ascertained that the data disk 3205 is the same as the data disk used before the power supply is turned off, and therefore the data disk 3205 is mounted (step S3707). Then, the history information recorded in the internal memory 3206 of the first controller 3201 is updated, and the server apparatus 101 is brought into the normal execution state (step S3708). The process is then terminated.

On the other hand, if there is a history of removal of the data disk 3205, a warning message is transmitted to the desktop PC 103 via the network 102 without mounting the data disk 3205 (step S3709). Then, the history information recorded in the internal memory 3206 of the first controller 3201 is updated to complete the activation of the first controller 3201 (step S3710). The process is then terminated.

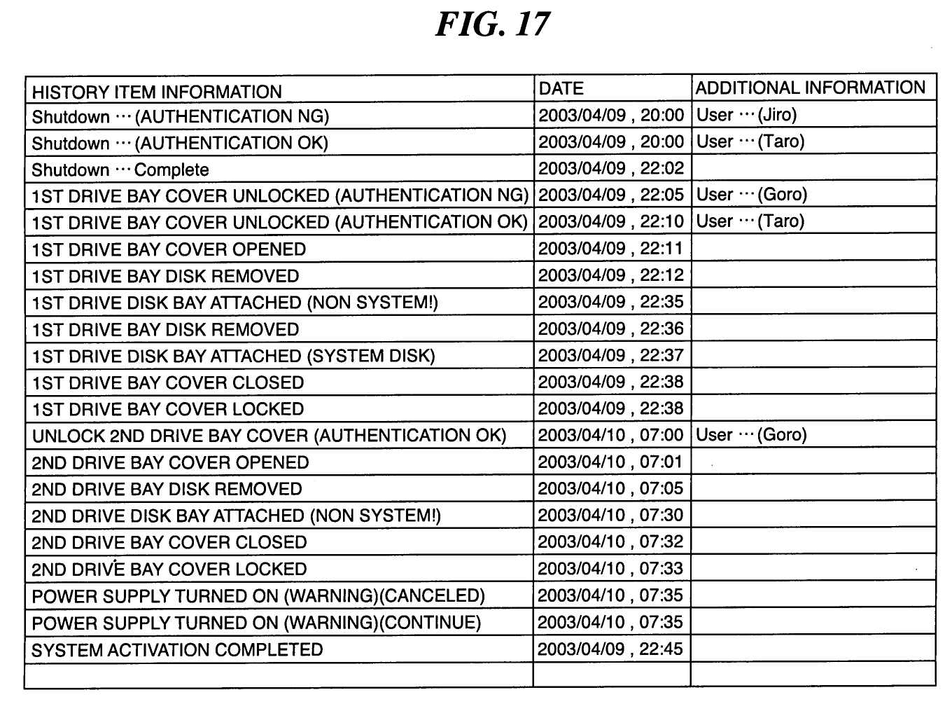

FIG. 17 is a view showing an example of history information recorded in the internal memory 3313 of the second controller 3301 in the processes of FIGS. 11 to 16.

As shown in FIG. 17, history information is comprised of history item information indicative of the type of an event which shows the contents of the process in any of FIGS. 11 to 16 or the processing result thereof, the date and time of occurrence of the event, and additional information added depending on the event. For example, a user name which has been input is recorded as additional information to history information on an event related to user authentication OK/NG in the step S3203 in FIG. 12.

According to the present embodiment, the attachment/removal of the removable system disk 3204 and data disk 3205 and the operative statuses of the covers 1011 and 1012 and others while the power supply to the server apparatus 101 is off can be recognized as history information, and therefore it is possible to improve security for the removable system disk 3204 and data disk 3205 at low cost. In particular, the activation of the server apparatus 101, the handling of the system disk 3204 and the data disk 3205 after activation, and so forth corresponding to history information recorded while the power supply to the server apparatus 101 is off are displayed, such as the display of a warning message that the system disk 3204 has been attached/removed while the power supply to the server apparatus 101 is off, and therefore it is possible to realize more refined security management.

It should be noted that although in the present embodiment, the RS232C standard is applied to communication between the first controller 3201 and the second controller 3301, the present invention is not limited to this, but a USB standard may be applied.

Further, history information may be transmitted from the first controller 3201 to the second controller 3301 by using not only the cable 3404, but also, for example, a shared memory which both the first controller 3201 and the second controller 3301 can access.

Further, although in the above described first to third embodiments, the present invention is applied to the cover unlocking process, but it goes without saying that the present invention may be applied to a cover locking process as well.

Further, although in the above described embodiments, the user is authenticated according to a password input via the touch panel, the present invention is not limited to this, but the user may be authenticated using a fingerprint, a magnetic card, or the like.

It goes without saying that the object of the present invention may also be accomplished by supplying a system or an apparatus with a storage medium (or a recording medium) in which a program code of software, which realizes the functions of any of the above described embodiments is stored, and causing a computer (or CPU or MPU) of the system or apparatus to read out and execute the program code stored in the storage medium.

In this case, the program code itself read from the storage medium realizes the functions of any of the above described embodiments, and hence the program code and a storage medium on which the program code is stored constitute the present invention.

Further, it is to be understood that the functions of any of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of any of the above described embodiments may be accomplished by writing the program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

Further, the above program has only to realize the functions of either of the above-mentioned embodiments on a computer, and the form of the program may be an object code, a program executed by an interpreter, or script data supplied to an OS.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program is supplied by downloading from another computer, a database, or the like, not shown, connected to the internet, a commercial network, a local area network, or the like.

What is claimed is:

1. An information processing apparatus comprising:
an attachment section to which a removable storage unit is attached;
a first controller that controls operation of the information processing apparatus; and
a second controller that controls operation of said attachment section;
wherein said first controller cooperates with said second controller.

2. An information processing apparatus according to claim 1, wherein said second controller shares predetermined information for managing status of said attachment section with said first controller.

3. An information processing apparatus according to claim 2, wherein said second controller shares the predetermined information with said first controller irrespective of operative status of said first controller.

4. An information processing apparatus according to claim 2, comprising information storage means for storing the predetermined information, and wherein the predetermined information is readable from said information storage means by said second controller and writable to said information storage means by said first controller.

5. An information processing apparatus according to claim 4, wherein:
said attachment section comprises at least one openable and closable cover member that covers the storage unit;
the information processing apparatus comprises electronic lock means for electronically locking and unlocking said cover member, and input means for inputting authentication information including a password for closing or opening said cover member;
said first controller writes the authentication information as the predetermined information to said information storage means;
said second controller comprises determining means for determining whether the input authentication information coincides with the predetermined information stored in said information storage means; and
said electronic lock means locks or unlocks said cover member when the authentication information coincides with the predetermined information.

6. An information processing apparatus according to claim 5, wherein said second controller comprises number-of-times determining means for determining whether a number of times said determining means has determined that the authentication information does not coincide with the predetermined information is greater than a predetermined number of times, and deleting means for deleting authentication information stored in said information storage means when the number of times said determining means has determined that the authentication information does not coincide with the predetermined information is greater than the predetermined number of times.

7. An information processing apparatus according to claim 6, wherein said first controller comprises reset means for resetting the authentication information deleted by said deleting means.

8. An information processing apparatus according to claim 1, comprising:
attachment/removal detecting means for detecting attachment and removal of the storage unit to and from said attachment section;
first power supply means for supplying power to said first controller;
second power supply means for supplying power to said second controller; and
history storage means operable when said attachment/removal detecting means detects attachment or removal of the storage unit to or from said attachment section, to store information indicative of the attachment or removal as history information, and
wherein said history storage means is operative even when power supply to said first controller by said first power supply means is off.

9. An information processing apparatus according to claim 8, comprising:
type detecting means for detecting a type of the storage unit attached to said attachment section by determining whether the storage unit is a system storage unit storing a system program for activating said first controller; and
wherein said history storage means is operable when said attachment/removal detecting means detects removal of the system storage unit from said attachment section, to store information indicative of the removal as history information.

10. An information processing apparatus according to claim 8, wherein:
said attachment section comprises a first attachment section for attaching exclusively a system storage unit storing a system program for activating said first controller, and a second attachment section for attaching exclusively a general-purpose storage unit;
said attachment/removal detecting means comprises first attachment/removal detecting means provided in said first attachment section, and second attachment/removal detecting means provided in said second attachment section; and
said history storage means is operable when said first attachment/removal detecting means detects removal of the system storage unit attached to said first attachment section, to store information indicative of the removal as history information.

11. An information processing apparatus according to claim 9, comprising display means for displaying information, and input means for externally inputting information; and
wherein said second controller comprises power supply control means for controlling turning-on of power supply to said first controller, and removal determining means for determining whether removal history information indicative of removal of the system storage unit is included in the history information stored in said history storage means; and
wherein said second controller is operable when said removal determining means determines that the removal history information is included in the history information, to cause said display means to display a warning message before turning-on of power supply to said first controller, bring the information processing apparatus into a state waiting for external input of information to the effect that the warning message has been confirmed, and cause power supply to said first controller to be turned on after the external input of the information.

12. An information processing apparatus according to claim 9, wherein:
said history storage means is operable when said attachment/removal detecting means detects removal of a data storage unit used for data storage from said attachment section, to store information indicative of the removal as history information;
said second controller comprises history transmitting means operable when said first controller is activated, to transmit the history information stored in said history storage means while power supply to said first controller is off, to said first controller; and
said first controller comprises history receiving means for receiving the history information from said second controller after said first controller is activated in accordance with the system program read out from the system storage unit, and wherein said first controller is operable when removal history information indicative of removal of the data storage unit is included in the received history information, to inhibit connection of the data storage unit associated with the removal history information to the information processing apparatus.

13. A method of controlling an information processing apparatus including an attachment section to which a removable storage unit is attached, comprising:
a first control step of controlling operation of the information processing apparatus through a first controller; and
a second control step of controlling operation of the attachment section through a second controller;
wherein said first control step is executed in cooperation with said second control step.

14. A method of controlling the information processing apparatus according to claim 13, wherein said second control step shares predetermined information for managing status of the attachment section with said first control step.

15. A method of controlling the information processing apparatus according to claim 13, comprising:
an attachment/removal detecting step of detecting attachment and removal of the storage unit to and from the attachment section;
a first power supply step of supplying power to the first controller;
a second power supply step of supplying power to the second controller; and
a history storage step of storing information indicative of attachment or removal as history information in history storage means when the attachment or removal of the storage unit to or from the attachment section is detected in said attachment/removal detecting step, and
wherein the history storage means is operative even when power supply to the first controller executed in said first power supply step is off.

16. A control program for causing a computer to execute a method of controlling an information processing apparatus including an attachment section to which a removable storage unit is attached, comprising:
a first control module for controlling operation of the information processing apparatus through a first controller; and
a second control module for controlling operation of the attachment section through a second controller,
wherein said first control module cooperates with said second control module.

17. A control program according to claim 16, wherein said second control module shares predetermined information for managing status of the attachment section with said first control module.

18. A control program according to claim 16 comprising:
an attachment/removal detecting module for detecting attachment and removal of the storage unit to and from the attachment section;
a first power supply module for supplying power to said first controller;
a second power supply module for supplying power to said second controller; and
a history storage module operable when said attachment/removal detecting module detects attachment or removal of the storage section to or from the attachment section, to store information indicative of the attachment or removal as history information in history storage means, and
wherein the history storage module is operative even when power supply to said first controller by said first power supply module is off.
